(19) United States
(12) Patent Application Publication
(10) Pub. No.: US 2006/0266164 A1
(43) Pub. Date: Nov. 30, 2006

(54) Open-ended ratcheting wrench having adjusting mechanism

(76) Inventor: Hua Gao, Fox Point, WI (US)

Correspondence Address: RYAN KROMHOLZ & MANION, S.C., POST OFFICE BOX 26618, MILWAUKEE, WI, 53226, US

(21) Appl. No.: 11/141,553

(22) Filed: May 31, 2005

(51) Int. Cl. B25B 13/18

(52) U.S. Cl. 81/128

(57) ABSTRACT

An adjustable ratcheting wrench having a handle, a fixed jaw secured the handle and an adjustable jaw pivotally attached to the handle. The wrench further has an adjustment mechanism slidably connected the handle. The adjustment mechanism is in slidable contact with the adjustable jaw and further has an adjustment mechanism further having a locking mechanism. A locking area is located on the handle, which has a plurality of spaced apart locking stations. The locking mechanism is releasably engageable with the locking stations to thereby secure the adjustable jaw in a plurality of fixed positions.

### BACKGROUND OF THE INVENTION

The present invention relates to adjustable wrenches and, more specifically, adjustable wrenches that have ratcheting features.

Adjustable wrenches, ratchets, and sockets have been previously known. However, the known prior art wrenches generally have shortcomings. Closed end tools, such as sockets, may not be easy to get around a nut, especially in tight areas. If a bolt extends too far outwardly from the nut, it is possible that the socket will not properly surround and secure the nut, which could lead to stripping of the nut. The same may be said for closed end ratchets. It may be difficult to get the ratchet over a bolt and properly positioned on a nut, potentially stripping the nut.

Open-ended adjustable wrenches, such as crescent wrenches, also have limitations. Generally, these wrenches are not easily tightened to the proper nut size, which can also lead to stripping of the nut. Similarly, it is not always possible to use the required amount of torque, because of the above noted problem of not easily adjusting the wrench to the proper nut size.

Because of problems of stripping the nuts, many mechanics and the like need to keep several wrenches and ratchets on hand to accommodate potentially different sized nuts. It would be advantageous to have a single tool that could securely adjust to varying sizes of nuts, and also could be easily and properly fitted to nuts of varying sizes. Furthermore, the tool should be able to withstand a high amount of torque without fear of stripping the nut.

### SUMMARY OF THE INVENTION

The present invention is for an open-ended adjustable ratcheting wrench. The wrench has a fixed jaw and an adjustable jaw. The adjustable jaw is connected to an adjustment mechanism that allows the wrench to be adjusted to specific nut sizes by sliding a locking pin into a notch that corresponds to a specfic nut size. The fixed jaw is designed to allow the wrench to act as a ratcheting-style wrench.

### BRIEF DESCRIPTION OF THE DRAWINGS

FIG. 1 is a perspective view of a wrench in accordance with the present invention.

FIG. 2 is a partially cut-away side plan view of the wrench of FIG. 1 in a first adjusted position.

FIG. 3 is a partially cut-away side plan view of the wrench of FIG. 1 in a second adjusted position.

FIG. 4 is a perspective view of a fixed jaw in accordance with the present invention.

FIG. 5 is a perspective view of an adjustable jaw in accordance with the present invention.

FIG. 6 is perspective view of another unitary construction adjustable jaw in accordance with the present invention.

FIG. 7 is a perspective view of an adjustment mechanism in accordance with the present invention.

FIGS. 8-10 are close-up side views of jaws in accordance with the present invention.

FIG. 11 is a close-up view of the wrench of the present invention performing a ratcheting function.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims. As will be understood, like parts will be referred to with like reference numerals.

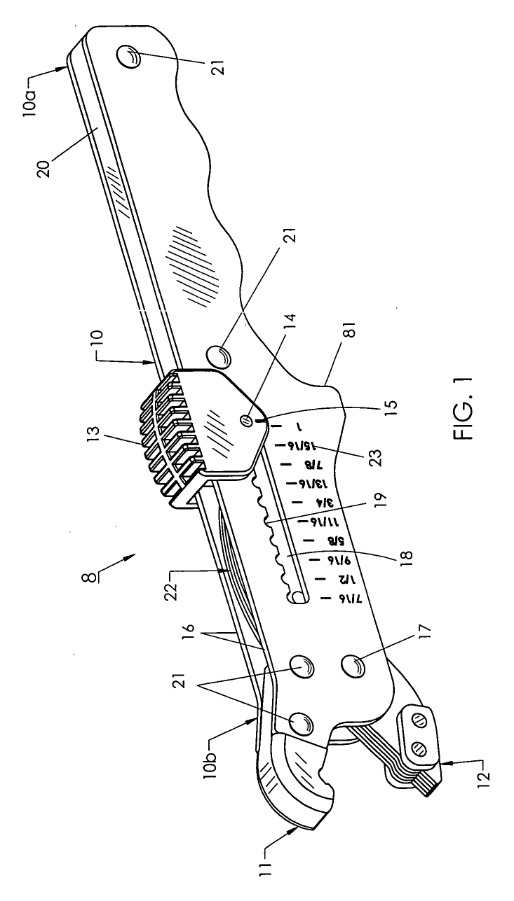

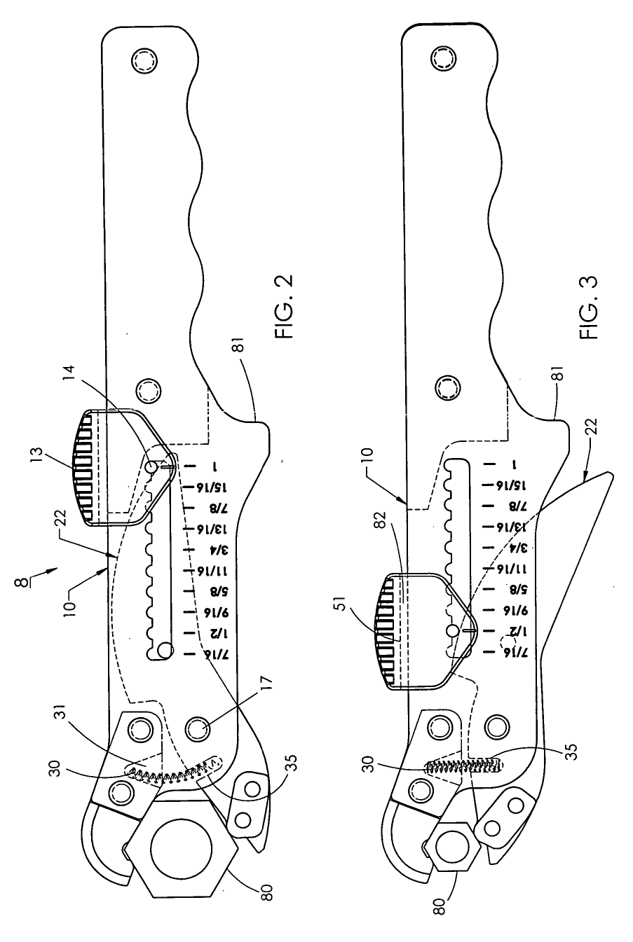

FIG. 1 depicts an adjustable ratcheting wrench 8. The wrench 8 has a lever arm or handle 10 having a first end 10a and a second end 10b. The first end 10a generally provides an area for the wrench to be gripped. The second end lob of the handle is securely connected to a fixed jaw 11 and pivotally connected an adjustable jaw 12 by way of a pivot pin 17. An “n” type button 13 is slidingly connected to the handle 10 by way of a locking pin 14. The button 13 provides adjustment means for the wrench 8. An indicator 15 located on the button 13 allows a person to properly adjust the wrench 8 for the correct size of a nut. The locking pin 14 slides along a locking area or window slot 18, which contains a plurality of locking stations shown as radial notches 19 that correspond to predetermined nut sizes. The notches 19 preferably correspond to a plurality of scale marks 23 to indicate the nut sizes. When one of the notches 19 receives the locking pin 14, the upward pressure exerted on the pin 14 from the adjustable jaw 12 will secure and lock the pin 14 within the notch 19 until the user adjusts the button 13. The adjustable jaw 12 further comprises a radial arm 22 that comes into contact with the locking pin 14. The interaction of the pin 14 and the radial arm 22 will be discussed in more detail with respect to FIGS. 2 and 3.

Still referring to FIG. 1, the button 13 preferably slides along the handle 10 on the outside of a pair of opposing plates 16, which generally comprise the handle 10. The plates 16 are preferably connected together with several rivets 21, but other similar connecting means, such as pins, screws, bolts, clamps, adhesives and the like, may be used to connect the plates 16 and form the handle 10. The handle may also comprise a cushion 20 located between the plates 16 near the first end 10a of the handle 10. The cushion 20 will make it more comfortable to use and hold the wrench 8 and can also act as a shock absorber for the user and properly space the plates 16 apart. The cushion could be made of plastic or other material that will act as a proper spacer or spacing device for the handle 10 and the plates 16.

Referring now to FIGS. 2 and 3, the wrench 8 is shown being adjusted to accommodate nuts 80 of varying sizes. A helical spring or compression spring 30 sits within a spring housing 31 located on the fixed jaw 11 and a second housing 35 located on the adjustable jaw 12 that allows the adjustable jaw 12 to be biased against the fixed jaw 11. The housing 31 is of a “V” shape, which assists in the movement of the adjustable jaw 12 by allowing the spring 30 to loosely float within the housing 31. The housing 35 has a “U” shape, which holds the spring 30 in position as the wrench 8 is adjusted. The housings 31 and 35 preferably of designed as having four flat walls and not cylindrical in shape, which is easier for manufacturing purposes.

Still referring to FIGS. 2 and 3, the pin 14 of the adjustment button 13 is shown interacting with the radial arm 22. The button 13 has an interior flat surface 51 that will contact the handle 10 when the button is pressed downwardly towards the handle 10. A space 82 is located between the handle 10 and the surface 51 to allow downward movement. Once the button 13 is pushed downward, the locking pin 14 will move out of one of the notches 19 and the user may move the button 13 forward or backward along the handle as needed. Thus, a user could adjust the wrench from the position in FIG. 2 to the position in FIG. 3. As shown in FIG. 3, the radial arm 22 may extend outwardly from the handle 10 for various nut sizes. A guard member 81 is preferably situated on the handle 10 to prevent the user from pinching the user's hand or fingers.

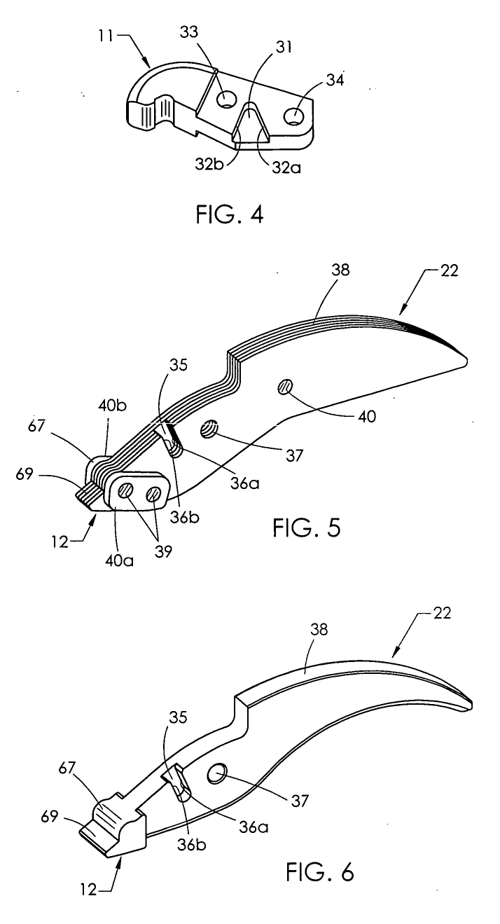

FIG. 4 shows a perspective view of the fixed jaw 11. The housing 31 has interior walls 32a and 32b, which provide the “V” shape previously discussed. Holes 33 and 34 allow the jaw 11 to be connected to the handle 10, as discussed and shown with respect to FIG. 1. The housing 31 is enclosed by one of the plates 16 (see FIG. 1). While the jaw 11 is shown and describe as a separate section from the handle 10, it is to be understood that the handle 10 and the jaw 11 could be integrally formed and still fall within the scope of the present invention.

FIG. 5 and 6 show embodiments of the adjustable jaw 12. As mentioned above, the “U” shaped housing 35 is designed to hold the spring 35 in proper position and orientation (see FIGS. 2 and 3). Walls 36a and 36b provide the sides for the housing 35, while one of the plates 16 encloses the housing 35, similarly as discussed for the housing 31 in FIG. 4. A pivot hole 37 allows the adjustable jaw 12 to be connected to the handle 10 by the pivot pin 17 (see FIG. 1). The radial arm 22 has a curvate surface 38 that interacts with the locking pin 14 (see FIGS. 2 and 3). The radial arm surface 38 is designed so that it is preferably tangentially positioned with respect to the diameter of the locking pin 17 (see FIGS. 2 and 3), which provides further ease of movement of the jaw 12 when the locking pin 14 comes into contact with the surface 38.

Referring further to FIGS. 5 and 6, a radial projection 67 is shown. In FIG. 5, the projection 67 has a first member 40a and a second member 40b that are riveted to the jaw 12 with rivets 39. The projection 67 is projected outwardly from a central plane to include the first member 40a and the second member 40b. Another rivet 40 further secures the jaw 12 together. In FIG. 6, the radial projection 67 is integrally formed with the jaw 12. The jaw 12 also comprises a flat line surface 69 that assists in the ratcheting process and can be formed of a single piece of material (FIG. 6) or several pieces of material (FIG. 5) that are riveted together.

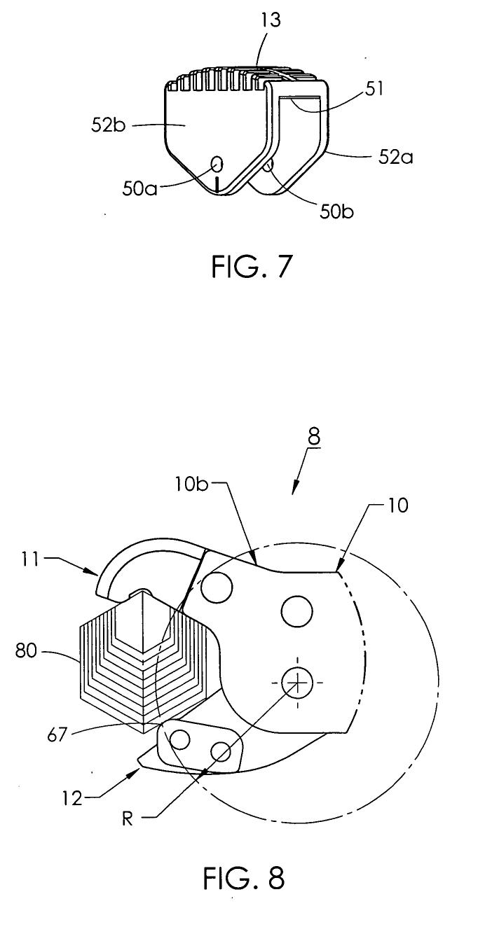

FIG. 7 provides a perspective view of the button 13. As noted with respect to FIG. 1, the button 13 is an “n” type button, which allows it to sit on and over the handle 10 (see FIG. 1). A first side 52a will reside on the outside of one of the plates 16 (not shown), and the second side 52b will reside on the outside of the other of the plates 16 (not shown). A first hole 50a is located in the first side 52a and a second hole 50b is located in the second side 52b. The holes 50a, 50b receive the locking pin 14 (see FIGS. 1-3). The holes 50a, 50b are preferably arranged parallel with one another to insure that the button 13 slides evenly and smoothly along the handle 10. It should be understood that button 13 is only exemplary of adjustment devices for the present invention. Provided that a device will allow the jaw 12 to be adjusted to differing dimensions, it will fall within the scope of the present invention.

FIG. 8 provides a close-up view of the jaws 11 and 12 grabbing and holding various sizes of nuts 80. The nut 80 will be held in place between the fixed jaw 11 and the radial projection 67 of the adjustable jaw 12. Depending on the size of the nut 80, the jaw 12 will pivot around the pivot pin 17. The radial projection 67 will move along the radius R, which allows the radial projection 67 to properly contact nuts of varying sizes.

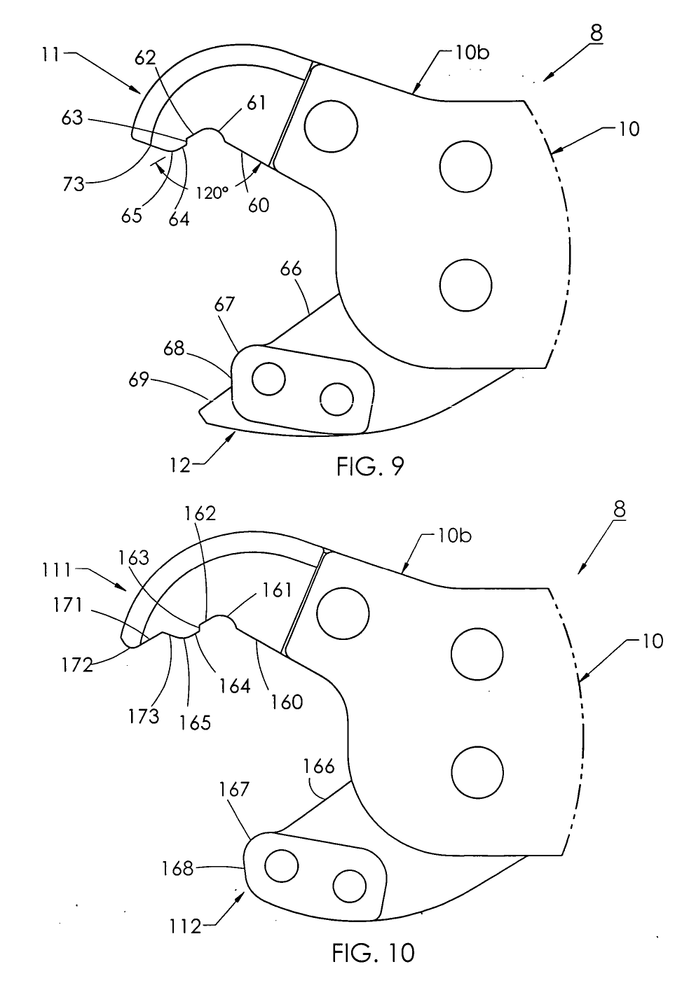

FIG. 9 shows an embodiment of the wrench 8. The jaw 12 has a surface designed to grab a nut. Working outwardly from the second end 10b the handle 10, the jaw 12 has a first flat section 60 that leads to a first curved radius section 61, which continues into a second flat section 62 that is tangential to the radius section 61. A step 63 protrudes from the second flat section 62 and continues into a third flat section 64, which leads into a second curved radius section 65. The second curved radius section 65 leads to a fourth flat section 73. The angle between the first flat section 60 and the third flat section 64 is preferably 120°, to accommodate normal sized hexagonally shaped nuts.

Referring further to FIG. 9 the adjustable jaw 12 is also shown. A first straight area 66 extends generally from the handle 10 and continues onto the radial projection 67. The radial projection 67 continues onto a second straight area 68, which further terminates in a third straight area 69. The radial projection 67 is projected outwardly from the straight areas 66 and 69 to insure that a nut is properly secure within a wrench (see FIG. 8).

FIG. 10 shows a second embodiment of the wrench 8 and jaws 111 and 112. The jaw 112 is similar to the jaw 12. Working outwardly from the second end lob of the handle 10, the jaw 111 has a first flat section 160 that leads to a first curved radius section 161, which continues into a second flat section 162 that is tangential to the radius section 161. A step 163 protrudes from the second flat section 162 and continues into a third flat section 164, which leads into a second curved radius section 165. The second curved radius section 165 leads to a fourth flat section 173, which leads to a fifth flat section 171 that is angled with respect to the section 173. The section 171 terminates in a radial 72.

The adjustable jaw 112 shown in FIG. 10 is also similar to the jaw 12. A first straight area 166 extends generally from the handle 10 and continues onto the radial projection 167. The radial projection 167 continues onto and terminates in a second straight area 168. The third straight area 69 is no longer present, since the fifth flat section 171 of the jaw 111 provides the necessary ability for the wrench 8 to perform ratcheting functions.

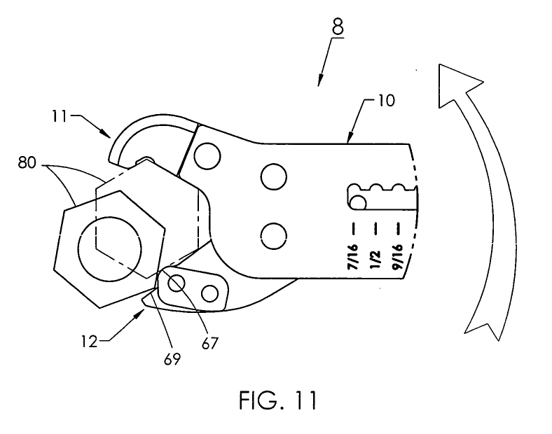

FIG. 11 demonstrates the ratcheting function of the wrench 8. The nut 80 is shown in phantom in a locking position, secured between the jaws 11 and 12. Once it is desired to move the wrench 8 to another position, the handle 10 will be moved in a reverse direction, which allows the nut 80 to be released from the jaws 11, 12. The nut 80 can rest upon the third straight area 69 as the handle is moved in the reverse direction, thereby allowing the user to keep the wrench 8 in contact with the nut 80 when performing a ratcheting function. Once a desired position is reached, the wrench 8 can be slide back around the nut 80 and tightening or loosening of the nut 80 may continue.

The wrench 8 of the present invention provides a simple, yet durable adjustable wrench 8 that can replace wide number of other wrenches. The wrench can be designed for English, metric, or other units, and can have as many different sizes as desired. The wrench is preferably used on hexagonal nuts or objects, but could also be used on square nuts or other polygonal-shaped objects. Furthermore, because the wrench is open-ended, it is more convenient to use in tight areas where a socket wrench or closed-ended might not be practical. The locking mechanism allows a bolt to be held in place easily and simply, while still allowing simple adjustment from one size to another. Also, the present wrench is much easier to use than prior art wrenches that use adjustment screws. The user can quickly adjust the wrench for a different nut size in an exact and precise manner. These wrenches have much more of a tendency to loosen during use or not be exactly fit to a nut, both of which are problems that can lead to rounding the corners of a nut and stripping the nut. Thus, the present invention is easier and quicker to use and, also, will not cause as much potential damage to nuts as prior art designs.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An adjustable wrench comprising:
a handle having a first end and a second end;
a fixed jaw secured to said second end of said handle;
an adjustable jaw pivotally attached at a pivot point to said handle, said handle having a first section in cooperating, gripping relationship with said fixed jaw and a second section having a curvate surface;
an adjustment mechanism slidably connected to said handle, said adjustment mechanism being in slidable contact with said curvate surface of said adjustable jaw, said adjustment mechanism further comprising a locking mechanism; and
a locking area located on said handle, said locking area comprising a plurality of spaced apart locking stations, said locking mechanism being releasably engageable with said locking stations to thereby secure said adjustable jaw in a plurality of fixed position.

2. The adjustable wrench according to claim 1 further comprising means for biasing said adjustable jaw against said fixed jaw.

3. The adjustable wrench according to claim 2 wherein said biasing means further comprises a spring being releasably engageable with said adjustable jaw and said fixed jaw, said spring being either a compression or helical spring.

4. The adjustable wrench according to claim 2 further comprising a housing having a first housing section located within said fixed jaw and a second housing section being located within said adjustable jaw, said biasing means being located within said housing.

5. The adjustable wrench according to claim 4 wherein said first housing section is V-shaped and said second housing section is U-shaped, each of said housing sections comprising four flat walls.

6. The adjustable wrench according to claim 1 wherein said handle further comprises a pair of parallel space plates, said adjustable jaw being pivotally attached between said plates.

7. The adjustable wrench according to claim 1 wherein said locking area further comprises a window slot containing a plurality of notched areas, said notched areas forming said locking stations.

8. The adjustable wrench according to claim 7 wherein said locking mechanism further comprises a locking pin, said pin being releasably engageable with said notched areas.

9. The adjustable wrench according to claim 8 wherein said curvate surface is in a tangential relationship with the diameter of said locking pin.

10. The adjustable wrench according to claim 1 wherein said fixed jaw is integrally formed with said handle.

11. An adjustable ratcheting wrench for grasping a polygon-shaped object, said wrench comprising:
a handle having a first end and a second end;
a fixed jaw secured to said second end of said handle;
an adjustable jaw pivotally attached at a pivot point to said handle, said handle having a first section in cooperating, gripping relationship with said fixed jaw and a second section having a curvate surface;
a flat support area located on one of said jaws, said area providing support means for said polygon-shaped object when performing a ratcheting action with said wrench.
an adjustment mechanism slidably connected to said handle, said adjustment mechanism being in slidable contact with said curvate surface of said adjustable jaw, said adjustment mechanism further comprising a locking mechanism; and
a locking area located on said handle, said locking area comprising a plurality of spaced apart locking stations, said locking mechanism being releasably engageable with said locking stations to thereby secure said adjustable jaw in a plurality of fixed position.

12. The wrench according to claim 11 wherein said support area is located on said fixed jaw.

13. The wrench according to claim 11 wherein said support area is located on said adjustable jaw.

14. The adjustable wrench according to claim 13, wherein said locking mechanism is normally biased within one of said notched areas.

15. The adjustable wrench according to claim 11 wherein said locking area further comprises a window slot containing a plurality of notched areas, said notched areas forming said locking stations.

16. The adjustable wrench according to claim 15 wherein said locking mechanism further comprises a locking pin, said pin being releasably engageable with said notched areas.

17. The adjustable wrench according to claim 16 wherein said curvate surface is in a tangential relationship with the diameter of said locking pin.

18. The adjustable wrench according to claim 11 wherein said adjustable jaw further comprises:
a first straight area extending from said handle;
a radial projection connected to said first straight area;
said flat area connected to said radial projection opposite of said first straight area;
and said radial projection extending outwardly towards said fixed jaw from said first straight area and said flat area.

19. The adjustable wrench according to claim 18 wherein said fixed jaw further comprises:
a first flat section extending from said handle;
a first curved radius section connected to said first flat section;
a second flat section tangentially connected to said first curved radius section;
a step protruding from said second flat section;
a third flat section connected to said step; and
a second curved radius section;
said first flat section and said third flat section being angularly disposed at 120°.

20. The adjustable wrench according to claim 18 wherein said radial projection further comprises a first exterior member and a second exterior member, said radial projection being aligned on a central plane between said first exterior member and said second exterior member.

21. The adjustable wrench according to claim 11 wherein said adjustment assembly further comprises an n-shaped button slidably connected to said handle.

22. The adjustable wrench according to claim 11 further comprising a guard member located on said handle.
